(19) United States
(12) Patent Application Publication
(10) Pub. No.: US 2009/0100105 A1
(43) Pub. Date: Apr. 16, 2009

(54) Methods and Systems for Facilitating Image Post-Processing

(75) Inventors: Christy Mutchler, Crestwood, KY (US); Heather Brown, Shelbyville, KY (US); Peter Herbener, Louisville, KY (US); Rob Falk, Jeffersonville, IN (US); Dave Ferguson, Louisville, KY (US); Michael Lillig, Jeffersonville, IN (US)

Correspondence Address: FROST BROWN TODD, LLC, 2200 PNC CENTER, 201 E. FIFTH STREET, CINCINNATI, OH, 45202, US

(73) Assignee: 3DR Laboratories, LLC, Louisville, KY (US)

(21) Appl. No.: 12/248,375

(22) Filed: Oct. 9, 2008

Related U.S. Application Data
(60) Provisional application No. 61/124,829, filed on Oct. 12, 2007.
(60) Provisional application No. 60/982,172, filed on Oct. 24, 2007.

(51) Int. Cl. G06F 17/30; G06Q 50/00; G09B 7/00

(52) U.S. Cl. 707/104.1; 705/2; 434/362; 707/E17.019

(57) ABSTRACT

Postprocessing of medical images (e.g., MRI and CT images) can be facilitated by a variety of techniques, including training methods which include modular organization and/or online presentation, postprocessing protocols which can be used to specify activities which can be predictably and consistently performed by technologists, and deployment of thin client image processing technology. Additional beneficial results relative to what is possible with the prior art can be obtained by combining one or more of the above approaches.

### CROSS REFERENCE TO RELATED APPLICATIONS

The present application claims the benefit of U.S. Provisional Patent Application Ser. No. 60/982,172, filed Oct. 24, 2007, the disclosure of which is hereby incorporated by reference in its entirety. The present application claims the benefit of U.S. patent application Ser. No. 11/871,594, filed Oct. 12, 2007, and later converted into U.S. Provisional Patent Application Ser. No. 61/124,829, the disclosure of which is also hereby incorporated by reference in its entirety.

### FIELD

This invention is in the field of medical image postprocessing, with particular embodiments including innovations in training, protocols, and postprocessing systems.

### BACKGROUND

It is known in the art that three dimensional visualization can be an effective tool for assisting doctors in the diagnosis and treatment of patient disorders. However, while three dimensional visualization is known to be an effective tool, there are substantial hurdles to realization of the full potential of that tool. For example, because three dimensional images must be reconstructed from automatically acquired two dimensional images (“slices”) by knowledgeable professionals (“technologists”), many facilities do not utilize three dimensional visualization because they do not have sufficient demand to support in-house technologists. And in house technologists are often poorly trained and don't see sufficient volumes of studies to maintain and expand their skills. While outsourcing is a potential solution to this obstacle, known outsourcing solutions have proven unsatisfactory due to the uneven and unpredictable quality of reconstructions which often results when reconstructions are performed by outsourced technologists. Other barriers to broader use of three dimensional visualization also exist. For example, existing techniques for technologist training and education have proven disruptive, expensive, and inadequate. Accordingly, there is a need for technologies which address one or more of the drawbacks which exist in the art.

### SUMMARY

Disclosed herein are various techniques and technologies which can be used in medical image postprocessing. For example, based on the disclosure set forth herein, one of ordinary skill in the art could implement a system comprising a upload interface, a database, and a first and second server. In such a system, the upload interface could be operable by personnel at a medical imaging facility to specify a scan for medical image postprocessing, and the database could be configured to receive the scan specified through the upload interface. The first server could then convert a notation associated with the scan into a normal form, automatically retrieve from a storage medium a plurality of skill indicators for a plurality of volumetric imaging technologists, automatically allocate the scan to a first volumetric imaging technologist based on a comparison between a skill indicator for the first technologist and a medical image postprocessing requirement for the scan, and provide the scan to the second server. Meanwhile, the second server could comprise a network connection configured to receive a plurality of commands input by the first volumetric imaging technologist into a volumetric imaging technologist terminal located remotely from the second server, and a processor configured to perform medical image postprocessing operations on the scan by executing the plurality of commands from the first volumetric imaging technologist.

As another example of a type of system which could be implemented by those of ordinary skill in the art without undue experimentation based on this disclosure, it is possible that a system could be implemented which comprises a database, a server, and a network connection. In such a system, the database might store data correlating one or more volumetric imaging technologists with one or more skill indicators. The server could then allocate a scan to a first volumetric imaging technologist based on a relationship between one or more skill indicators for the volumetric imaging technologist and a set of medical image postprocessing activities to be performed for the scan. The server could also provide the scan to the first volumetric imaging technologist, potentially in combination with a medical image postprocessing protocol indicating the set of medical image postprocessing activities to be performed for the scan. Subsequently, the server could receive a set of data from the first volumetric imaging technologist, the set of data comprising an image obtained from the scan through performance of the set of medical image postprocessing activities, and then store that set of data in a computer readable medium. Additionally, in such a system, the network connection could be in communication with the server such that the network connection is configured to transmit the set of data stored on the computer readable medium by the server.

Of course, the systems described above are not intended to be, and should not be treated as, exhaustive recitations of potential implementations of the technology disclosed herein. Additional variations and refinements on those systems are possible, some of which are disclosed explicitly herein, others of which would be immediately apparent to those of ordinary skill in the art in light of the explicit disclosure of this application. Further, other types of implementation, such as in the form of machines, computer programs or other data stored on computer readable media, or various types of processes are also possible and contemplated by the inventors. For example, the teachings of this disclosure could be used to implement a method comprising: establishing a connection between a terminal located proximate to a student and a postprocessing server located remotely from the student; providing a set of presentation information to the student, where the set of presentation information itself comprises a module training the student in performance of a medical image postprocessing protocol; providing an evaluation to the student, wherein providing the evaluation comprises providing the student a scan; receiving a set of input in response to the evaluation, wherein receiving the set of input comprises receiving a set of commands from the terminal, wherein the set of commands comprise postprocessing commands input by the student to execute the medical image postprocessing protocol for the scan; executing, via a postprocessing server, the set of commands; deriving a skill indicator for the student based on the set of student input; transmitting a set of display information from the postprocessing server to the terminal, where the set of display information indicates a result of execution of the set of commands; and, storing the skill indicator in a computer readable medium.

Of course, the above discussion should be understood to be illustrative, and not exhaustive of potential implementations of the technology disclosed herein.

### BRIEF DESCRIPTION OF THE DRAWINGS

FIG. 1 depicts components which could be used in a system for outsourced medical image postprocessing.

FIGS. 2a-2d depict configurations where equipment at multiple locations could interact to perform medical image postprocessing.

FIGS. 3a-3c depict equipment which might be used in the operation of an outsourced postprocessor.

### DETAILED DESCRIPTION

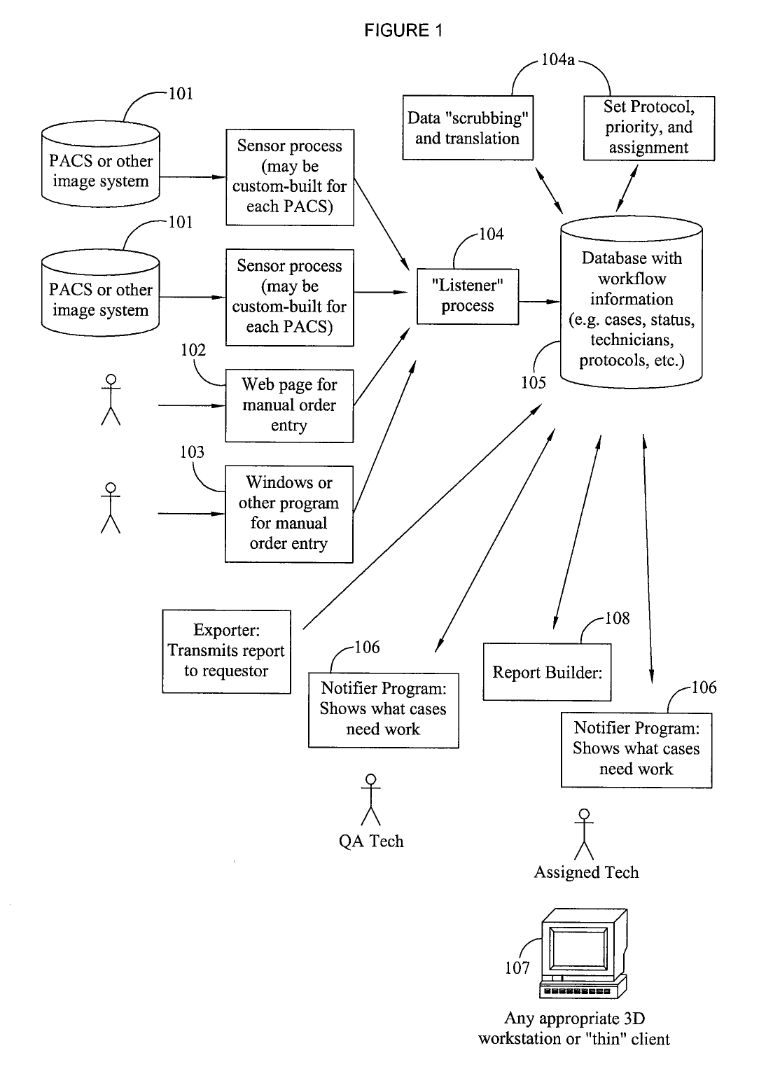

Turning now to FIG. 1, that figure depicts components which could be used in a system for outsourced medical image postprocessing. In FIG. 1, personnel at a medical imaging facility could specify a scan for medical image postprocessing using an upload interface. For example, doctors (or other personnel at a facility which desires to use the services of the outsourced postprocessor) could store scans requiring postprocessing in a picture archiving communication system (“PACS”) [101]. Such a PACS could be located at the client site (e.g., a hospital), or could be a PACS at the site of the outsourced postprocessor, where it might be integrated with one or more servers located at the postprocessor site which perform tasks such as described herein. The personnel could also use other tools to provide scans to the outsourced postprocessor, such as a web page configured for manual order entry [102], or some type of Windows or other computer program which could be specifically designed for order entry [103]. In some situations, the software used to enter the information (whether into a PACS server [101], through a web page [102] or dedicated program [103]) could also be used to obtain particular types of information about the scan, such as a description of the image entered, when the image was made, a referring physician, and/or other information. This information could also be obtained through the use of a separate process (e.g., a sensor), which would detect when a new scan was entered into a PACS or through some other type of tool, and is activated by that new entry (e.g., a listener process triggered by the new entry, a scanner which examines the contents of a repository at intervals and checks if the contents have changed since the last examination, or some other type of software routine). Using such software, the outsourced postprocessor could be notified when the scan, and any other related data, had been made available for medical image postprocessing.

With the scan and associated information having been made available, software operated by the outsourced postprocessor (e.g., processes running on a gateway server) could then be used to trigger postprocessing for the scan, and/or to facilitate the postprocessing itself. For example, as shown in FIG. 1, a listener process [104] could be used to learn that the information is available (e.g., by receiving a message from a sensor, or by performing acts such as described above, in the case where the sensor and the listener are integrated). Further, in some implementations a listener process could be implemented to perform additional tasks, such as saving raw data received from the sensor into a database [105] maintained by the outsourced postprocessor, cleaning up, and/or fleshing out the information provided. For example, a hospital might enter “AAA”, “aaa”, or “Ab. Aortic An” for a particular task. To facilitate processing, a program could run to convert those notations into a normal form, reflecting the fact that each of “AAA”, “aaa”, and “Ab. Aortic An” have the same meaning. This conversion might be based on a variety of types of information, such as rules, processing directives, stored conversion information, or other information as appropriate to a particular implementation. As another example of the type of processing a listener process [104] might perform in order to facilitate medical image postprocessing, in some cases particular doctors might prefer different images or measurements for the same type of study (e.g., as specified in a protocol). To facilitate this, an outsourced postprocessor might maintain a database which would include indications of what the preferences (if any) are for particular doctors, and the listener process [104] could then be configured to access that database to determine and fill in how those preferences could be satisfied (e.g., by specifying what protocols to use).

Of course, it should be understood that the features described above are provided simply for the purpose of illustrating functionalities which could be implemented in a listener process

, and are not intended to imply that a listener process [104] is required to include those functionalities, or that those functionalities are even necessary in all outsourcing of medical image postprocessing. To the contrary, it should be understood that the functions described might be performed by processes other than a listener (e.g., additional processes [104a], shown in FIG. 1), or might not be performed at all. Additionally, it should be understood that, in some implementations, a listener [104] such as described and illustrated in FIG. 1 might not be implemented at all, in which case a sensor or interface such as described previously might communicate directly with the database [105] or other software maintained by the medical image postprocessor. Accordingly, the discussion above should be understood as being illustrative only, and not limiting on potential implementations of the disclosed technology.

Continuing with the discussion of FIG. 1, after the appropriate information had been entered into a database [105] at the postprocessor, a notifier program [106] could be used to indicate to various technologists what studies are available for medical image postprocessing. This might be performed in a variety of manners, such as by updating a worklist which the technologist could use to select a study to perform medical image postprocessing on, by specifically assigning particular studies to particular technologists, or by some other means (e.g., a combined approach, where low priority studies or studies which could be performed by a plurality of technologists could be put on a worklist for selection, while higher priority studies or studies which could only be performed by certain technologists would be assigned to a specific technologist). In some cases, the notifier program [106] can also be configured such that it would provide not only an indication of a study on which postprocessing is to be performed, but might also use information from the database to instruct the technologist in how postprocessing on the study should be performed (e.g., through the use of protocols). Of course, it should be understood that the functionality described above with respect to the notifier program could also be integrated into some other program, for example, the listener process [104], and that the description of the notifier program [106] given above is intended to be illustrative only, and not limiting.

Once a study has been allocated to a volumetric imaging technologist, the technologist could perform medical image postprocessing using a local (relative to the technologist) workstation

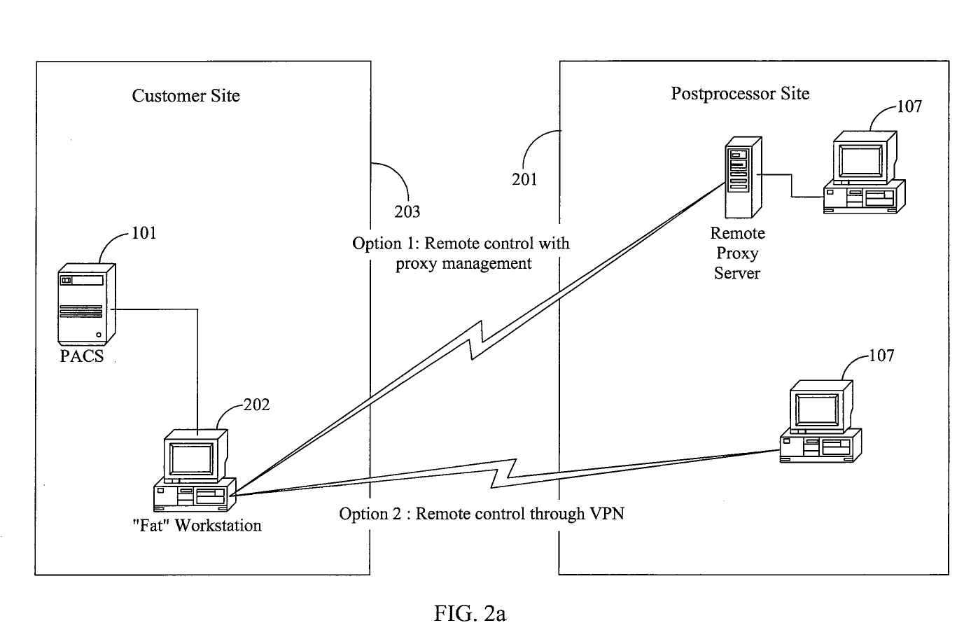

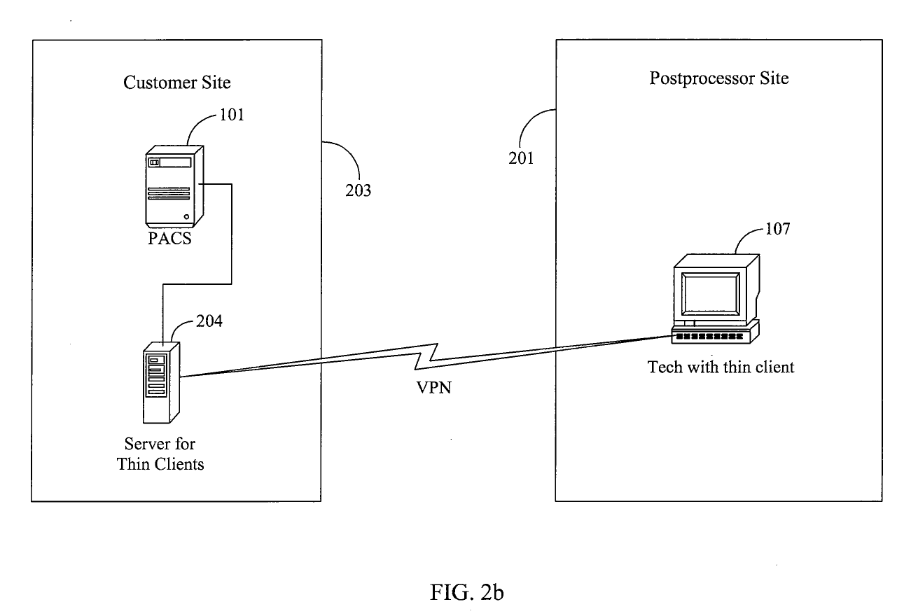

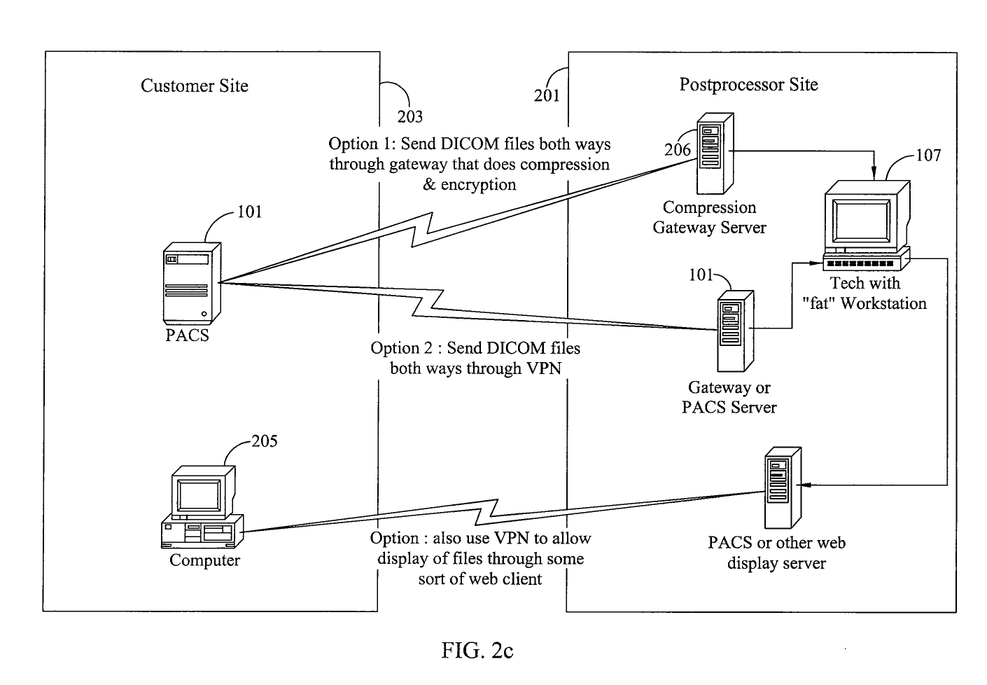

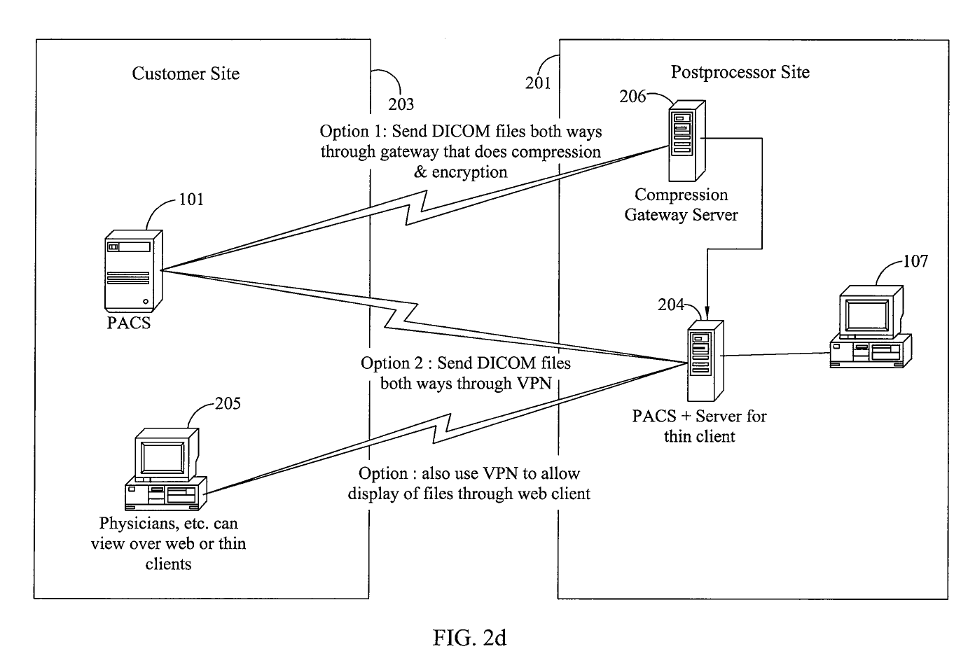

. As discussed below with reference to FIGS. 2a-2d, the local workstation [107] could operate in a variety of manners, including as a thin client for a server or fat workstation located either locally or remotely, or as a fat workstation itself. When actually performing the postprocessing, the technologist might use report builder software [108] which could be used to step the technologist through the required measurements and snapshots for a particular assignment (e.g., as might be specified in a protocol), and/or provide a template or a set format for use by the technologist in presenting the results of the postprocessing (potentially including comments the technologist believes might be beneficial such as that a doctor might wish to examine a particular feature when performing diagnosis or treatment). Additionally, in some cases an outsourced postprocessor might implement software which provides a protocol tickler (not shown) to a technologist. Such a tickler could be used to inform the technologist of a protocol which should be used for the assigned postprocessing, and might also include an interface element (e.g, a button, menu, etc.) which would allow the technologist to access instruction (e.g., a tutorial) on performance of the protocol. Such instruction could be particularly valuable when the assigned protocol is one which is not frequently used (or not frequently used by the assigned technologist), and in some cases, whether to provide the protocol tickler might be determined as a function of how rare the protocol is (e.g., the more rarely a protocol is used, the more likely the protocol tickler would be to be provided). Of course, it should be understood that the protocol tickler and report builder software [108] are presented as illustrations of the types of tools which could be used during medical image postprocessing, and accordingly should not be treated as implying limits on the invention as contemplated by the inventors, or used to in any way limit or narrow the claims included in this or any related application.

After the medical image postprocessing for a study has been completed, a system such as shown in FIG. 1 could send the result of the postprocessing to the server running software such as described previously, which could then send it to the customer who ordered the postprocessing to be performed, or could indicate some type of internal quality control review before the final deliverable is provided to the customer. There are a variety of ways that such quality control could be triggered. For example, in some circumstances, volumetric imaging technologists might undergo a period of training during which the work they perform would be reviewed as a matter of course. As an alternative (though of course it could also be implemented in combination with training related quality assurance), an outsourced postprocessor might allow a customer to specify specific additional quality control which would be performed on images processed for that customer, perhaps in exchange for an additional fee or for commitments to provide certain volumes of services. It is also possible that quality assurance could be triggered based on the postprocessing operations which were performed in a particular case (e.g., if postprocessing operations were performed in accordance with a relatively infrequently used protocol, then the quality control might be more likely to be triggered than if the operations were performed in accordance with a relatively more frequently used protocol). Of course, it is also possible that quality control review might not be performed selectively as disclosed above. For example, in some instances, the quality control review might be performed in all cases, or in no cases, or might be performed randomly, so that there would be a chance for the postprocessing review to take place in every case processed. Similarly, it is possible that quality control review could be performed after a deliverable has been provided to a customer, for example, to gather information about trends related to a particular technologist.

In terms of the quality control review itself, there are also a variety of techniques by which that could be implemented. In some cases, the quality control review could be completely automated. For example, in some cases, an outsourced postprocessor might maintain a plurality of medical image postprocessing protocols (discussed infra) which instruct a technologist how to perform postprocessing. In such cases, there could be software which could compare a result which would be expected based on the protocol (e.g., the technologist should have made certain notes, should have highlighted certain features, etc) with the actual deliverable provided by the technologist, and could flag discrepancies between the deliverable from the technologist and the expected result as actual or potential problems. It is also possible that the quality control might include human involvement, for example, there could be peer review in which other technologists (potentially senior technologists hired for the purpose) would review the results of the medical image postprocessing, and examine the original case themselves to ensure that the results of the medical image postprocessing were acceptable. Additionally, combined human-computer quality control review could also be implemented. For example, in some cases aspects of the quality control review could be performed by software (e.g., comparison of written material in reports) while other aspects (e.g., examination of images to verify acceptability) could be performed by humans. There could also be tiered quality control review, where a computer program performs a first level of review, and, if the first level of review indicates potential problems, then the case is escalated to a second level of human peer review.

Regardless of how it is completed, once the quality control has taken place, its results, including whether a case is acceptable, could be used to route the reviewed deliverable as appropriate. For example, if the quality control review indicated a problem, then the case could be routed for rework, perhaps to dedicated quality control technologists, to the original technologist who had performed the postprocessing (potentially with information about what needed to be changed), or to another technologist entirely. In some implementations, this routing for rework could use a notification program [106] and technologist selection techniques similar to those disclosed above with respect to the original selection of the technologist, though variations (e.g., routing to a dedicated quality control technologist) are also possible. Once any necessary review and rework has been completed, the final deliverable such as appropriate images and any reports which may have been produced can be sent to the appropriate recipient, such as the original requesting client.

Of course, it should be understood that FIG. 1 and the accompanying description are intended to provide disclosure of certain functions which could be utilized in performing outsourced medical image postprocessing, and should not be treated as an exhaustive recitation of the technology developed by the inventors. Indeed, numerous extensions and variations on the disclosure above are contemplated by the inventors and could be implemented by those of ordinary skill in the art without undue experimentation in light of this disclosure. Certain of those extensions and variations, as well as potential applications of the inventors' technology outside of the area of outsourced medical image postprocessing are discussed herein, though it should be understood that the following disclosure, like the disclosure set forth above regarding FIG. 1, is intended to be illustrative only, and not limiting.

One aspect of the inventors' technology which was alluded to, but not addressed in detail above, are the potential arrangements and interactions of systems used in the performance of medical image postprocessing operations. As contemplated by the inventors, there are a variety of configurations which could be used, both in the context of outsourced postprocessing, and in other applications. By way of illustration of this, four different configurations where equipment at multiple locations could interact to perform medical image postprocessing are depicted in FIGS. 2a-2d. For the purpose of simplicity, the numbering of FIGS. 2a-2d is consistent with the numbering of FIG. 1, and the discussion of FIGS. 2a-2d is set forth in the context of outsourced postprocessing services. However, the various configurations shown in FIGS. 2a-2d are not limited to being implemented in the outsourced postprocessing context, and could also be utilized in other contexts, as may be appropriate in various situations.

Turning now to FIG. 2a, that shows a configuration in which a technologist located at a postprocessor site [201] could use a workstation [107] at the postprocessor site [201] to control a second workstation [202] located at the customer site [203] to perform the postprocessing operations. In the configuration of FIG. 2a, the workstation [107] used by the technologist would not actually host the software which would execute the medical image postprocessing operations. Instead, the workstation [202] located at the customer site

would host the software which executes the medical image postprocessing operations, and the workstation [107] used by the technologist would send commands which would control that software. In turn, the workstation [202] located at the customer site [203] would send back display information so that the technologist could see the effects of the postprocessing operations. Such a configuration as shown in FIG. 2a could be beneficial in circumstances such as where a PACS [101] or other image storage system is located at the customer site [203], since the workstation [202] at the customer site [203] can process studies stored on the PACS [101] based on commands received from the workstation [107] at the postprocessor site [201] without having to send the entire study to the postprocessor site

. A similar configuration is shown in FIG. 2b, though instead of using the workstation

at the customer site [203] as shown in FIG. 2a, in FIG. 2b the postprocessing commands would be performed using a server [204] located at the customer site [203]. As with FIG. 2a, the configuration shown in FIG. 2b could be beneficial in cases where a customer does not wish to transmit full images to the postprocessor site [201].

Of course, it should be understood that not all configurations for performing postprocessing operations will utilize servers [204] or workstations [202] located at the customer site [203] to perform medical image postprocessing operations. An example of a configuration which could use software at the postprocessor site [201] to perform the actual medical image postprocessing operations is shown in FIG. 2c. In FIG. 2c, while there might be a PACS

at the customer site [203], the workstation [107] used by the technologist to perform medical image postprocessing would be a fat workstation located at the postprocessor site

. In such a situation, the images could be sent from the customer site [203] to the postprocessor site [201], where a gateway server [206] could send them to a technologist's workstation [107] where they would be processed. Once the images had been processed, the results of that processing (e.g., any derived images, notes, etc) could be sent from the technologist's workstation [107] to the gateway server [206], and from there back to the customer site [203]. Also, as shown in FIG. 2c, in such a configuration there could be further computers [205] located at the customer site [203] which could access information at the postprocessor site [201]. In various implementations, such computers [205] could be used to examine images being manipulated at the postprocessor site [201], or potentially could be used as thin client terminals in a manner similar to that discussed above with respect to FIGS. 2a and 2b. Of course, it should be understood that implementations in which the software used for medical image postprocessing is hosted at the postprocessor site [201] are not limited to the use of fat client workstations such as shown in FIG. 2c. For example, as shown in FIG. 2d, there could be a thin client server [204] located at the postprocessor site

. In such a case, the scan to be postprocessed would be provided from the gateway server [206] to the thin client server [204] which would actually perform the postprocessing. In operation, a technologist would enter the appropriate postprocessing commands into a workstation [107], which would be communicated to the thin client server [204] over a network (e.g., a LAN, in the event that the thin client server [204] and the workstation [107] are both located at the postprocessor site [201], or, potentially a WAN or other type of network if the technologist is at a different location). The thin client server [204] would then execute the commands received from the technologist, and transmit back a set of display information which would inform the technologist of the effect those commands had on the scan being postprocessed. Also, as shown in FIG. 2d, in such a configuration a computer

at the customer site [203] could potentially be used to view images during postprocessing, or could even be used in some cases as a thin client workstation itself.

Of course, it should be understood that the configurations shown in FIGS. 2a-2d are themselves intended to be exemplary of potential configurations, and should not be treated as implying limitations on the scope of the technology contemplated by the inventors or which could be implemented by those of ordinary skill in the art without undue experimentation. For example, while FIGS. 2a-2d depicted various computers as being located at either a customer site [203] or a postprocessor site [201], it is entirely possible that the operations described above could be performed at locations which are neither at the customer site [203] nor the postprocessor site [201]. For example, thin client processing could be performed by a technologist from his or her home computer, where commands would be sent to a server hosting the postprocessing software, and the results of those commands would be sent to the computer being used by the technologist, wherever that might be. Similarly, while the discussion of FIGS. 2a-2d focused on the use of fat client or thin client workstations, it should be understood that any particular implementation might have a variety of fat and thin client workstations, and that the specific equipment used in any particular situation will be dictated by the context of that situation, including any legacy equipment which may be available, bandwidth restrictions, and business agreements which the various entities involved may have made. Additionally, it should be understood that the components (e.g., postprocessing servers) might be duplicated or distributed differently than shown in FIGS. 2a-2d, in order to achieve purposes such as load balancing and network resource optimization, and that other components would likely be utilized in an actual implementation.

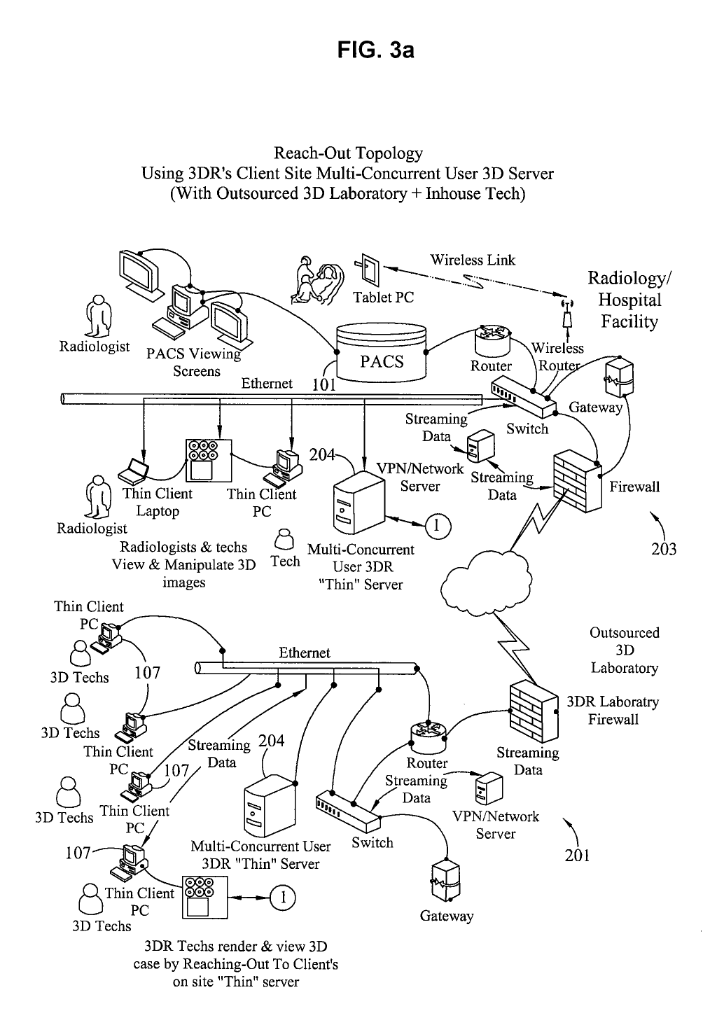

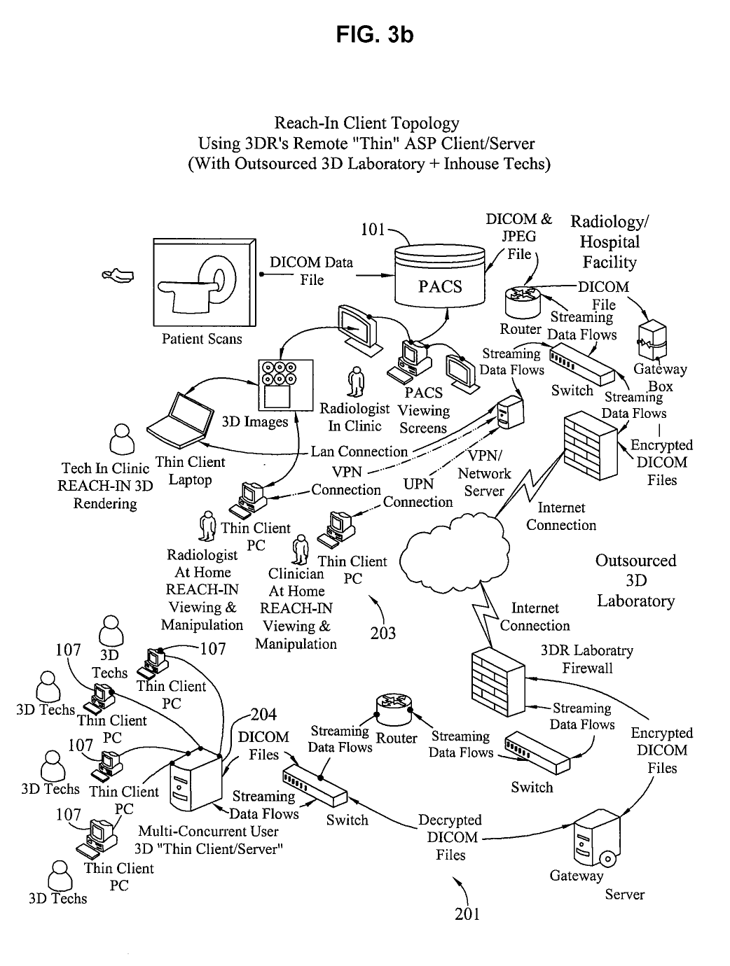

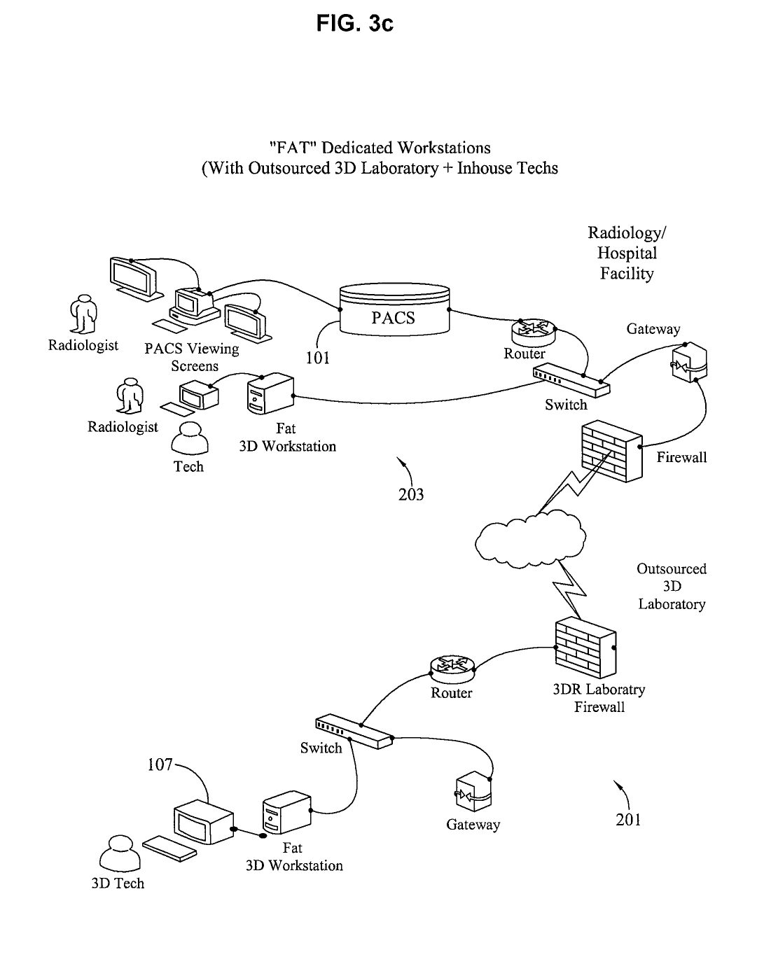

Further, it should be understood that FIG. 1, and FIGS. 2a-2d are simplified representations which allow for explanation of various tasks which could be performed in the operation of an outsourced postprocessor, but which are not intended to reflect all of the various components which might be used in an actual implementation. As an illustration of this, consider the diagrams of FIGS. 3a-3c, which depict in more detail equipment which might be used in the operation of an outsourced postprocessor as described above. FIG. 3a depicts a configuration that could be appropriate when there is a postprocessing server located at both the customer site [203] and at the postprocessor site [201]. In such a configuration, personnel working at the outsourced postprocessor could potentially use software stored at the server at the customer site [203] to perform image postprocessing, while the server hosting similar software at the postprocessor site [201] could provide redundant backup in case of failure of software at the customer site [203], or could be used for load balancing, or some other purpose. FIG. 3b depicts a configuration in which thin client postprocessing could be implemented using a server located at the postprocessor facility [201] without having a similar server located at the customer site [203]. In cases where a configuration such as shown in FIG. 3b is implemented, both the personnel at the customer site [203] and at the postprocessor site [201] could make use of the software at the server in the postprocessor site [201], perhaps through a virtual private network, or through some other communications technology. Finally, FIG. 3c depicts a configuration which could potentially be used for fat client processing where, as discussed above, the actual medical image postprocessing operations would take place on the workstations used by the various technologists.

Of course, it should be understood that, while FIGS. 3a-3c provided additional detail on implementations for outsourced postprocessing, those figures were also simplified to avoid detracting from their clarity by providing unnecessary details. For example, various databases which might be used, such as a PACS which could be located at the postprocessor site were not explicitly included in FIGS. 3a-3c, though one of ordinary skill in the art would understand that such databases could be present, especially given the discussion of FIG. 1. Similarly, various performance optimizations, such as the use of RAM only servers for medical image postprocessing were also not explicitly addressed above. Accordingly, it should be understood that the discussion of FIGS. 3a-3c is intended to be illustrative, and is not intended to show all potential tools that could be used by an outsourced postprocessor, or to show tools which would necessarily be used by all outsourced postprocessors.

A further aspect of the provision of outsourced medical image postprocessing which could be implemented using a system such as described above with respect to FIG. 1 is the preparation of scans for processing by a technologist. As discussed above, a listener process

(or some other process) could be used to perform some cleanup on scans provided for medical image postprocessing (e.g., converting equivalent notations such as “AAA” “aaa” and “Ab Aoritic An” to a standard form). However, further processing to facilitate postprocessing of the image could also take place. For example, software could be used to identify missing or incomprehensible data which is transmitted from an imaging facility. The missing or incomprehensible data could then be supplied programmatically (e.g., through the use of a database which stores default values for data for a particular facility or scan type where the data might have been omitted as too routine) or manually (e.g., using personnel at the postprocessor who might fill in data either based on their own knowledge, or by contacting the facility which provided the scan for postprocessing). Additionally, the listener process [104] (or some other process) could be used to assess the priority of the scan. This could be performed, for example, as a function of the type of case (e.g., fast turnaround for emergency treatment vs. reviewing data for a clinical trial), a service level agreement which might exist between the customer and the outsourced postprocessor, the likely time required for performing the particular postprocessing operations which would be appropriate for the scan, the workload of technologists who would be available and qualified to perform those postprocessing operations, and other factors as might be appropriate in a particular implementation.

Yet another type of function which could be performed by the listener process [104] (or some other process) is to determine protocols which should be followed when performing postprocessing on a scan. For example, to facilitate medical image postprocessing, an outsourced postprocessor could maintain a database of medical image postprocessing protocols. Such protocols might provide instruction for a technologist regarding features to identify in a scan, and how those features should be identified. Further, there might be custom protocols associated with particular doctors, practices or institutions (e.g., imaging facilities). In such a case, if the protocol was not provided with the scan by the doctor or imaging facility, the software used by the outsourced postprocessor could retrieve the appropriate custom protocol, and associate that with the scan for postprocessing. Similarly, there might be a database maintained which has protocols which can be correlated with the information that might be provided with a scan. For example, if the scan is associated with the notation “AAA,” the software could associate it with a protocol for an abdominal aortic aneurism. In this way, protocols could be used to inform a technologist of how postprocessing for a particular scan should be performed. As a further illustration of this, consider table 1, below, which sets forth certain protocols which could be used as described.

TABLE 1
Exemplary Protocols

| | |
|---|---|
| CORONARY CTA | Probe each artery and branch |
| PROTOCOL | RCA |
| | acute marginals |
| | LAD |
| | diagonals |
| | LCX |
| | obtuse marginals |
| | PDA |
| | Ramus branch (when present) |
| | In the case of CABG |
| | LIMA |
| | Any additional grafts |
| | Volume with Segmented Vessels |
| | 360 deg rotation |
| | Vessel analysis of each vessel |
| | Batch file of rotating longitudinal |
| | CPR views |
| | Straightened lumen views of any |
| | identified plaque |
| EXTREMITY RUNOFF | MPR Batch Files |
| CTA PROTOCOL | 15 mm MIPs |
| | Coronal and sagittal MPR |
| | 5 mm increments |
| | Volume with Segmented Vessels |
| | 360 deg rotation |
| | VR and MIP |
| | Shadow in bone |
| | Screen captures of AP/PA |
| | view of each region |
| | Vessel analysis of major arteries |
| | Batch files of longitudinal CPR |
| | views |
| CAROTID CTA PROTOCOL | MPR Batch Files |
| | 10 mm MIPs |
| | Coronal MPR through length of |
| | carotids |
| | 5 mm increments |
| | Sagittal and coronal MPR angled |
| | with aortic arch |
| | 5 mm increments |
| | Oblique angle through R/L carotid |
| | bifurcation |
| | 3 mm increments |
| | Volume with Segmented Vessels |
| | 360 deg rotation |
| | VR and MIP |
| | Screen captures of each carotid |
| | bifurcation in profile |
| | Shadow in bone |
| | Screen captures of AP/Lt. |
| | lateral/PA/Rt. Lateral |
| | Vessel analysis of both internal carotids |
| | Batch files of longitudinal CPR |
| | views |
| | Stenosis measurements (NASCET |
| | criteria) |
| | Curved reformat of each carotid |
| | artery through the siphon |
| | Curved reformat of each vertebral |
| CIRCLE OF WILLIS | MPR Batch Files |
| CTA PROTOCOL | 10 mm MIPs |
| | Sagittal MPR through cerebral |
| | arteries |
| | 5 mm increments |
| | Axial MPR through COW |
| | 3 mm increments |
| | Oblique coronal MPR angled with |
| | basilar artery |
| | 3 mm increments |
| | Volume with Segmented Vessels |
| | 360 deg rotation |
| | VR and MIP |
| | Shadow in bone |
| | Screen capture of superior |
| | view |
| | Vessel analysis of any plaque or aneurysm |
| | Batch file of longitudinal CPR view |
| | of plaque |
| | Aneurysm measurements |
| | Volume |
| | Maximum diameter |
| | Diameter of neck |
| ABDOMINAL AORTIC | MPR Batch Files |
| ANEURYSM CTA | 15 mm MIPs |
| PROTOCOL | Sagittal and coronal MPR through |
| | aorta |
| | 5 mm increments |
| | Oblique MPR through each renal |
| | artery |
| | 3 mm increments |
| | Volume with Segmented Vessels |
| | 360 deg rotation |
| | VR and MIP |
| | Shadow in bone |
| | Screen captures of |
| | celiac/SMA profile, renal |
| | and iliac bifurcations |
| | Vessel analysis of any stenotic arteries |
| | Batch file of longitudinal CPR view |
| | of plaque |
| | AAA Measurements |
| | Detailed volume, diameter and |
| | length measurements |
| | Follow-up EVAR reporting with |
| | previous measurements for quick |
| | comparison |
| | Endoleak analysis |
| | Endoleaks will be displayed in |
| | appropriate views to demonstrate |
| | endoleak type |
| PANCREAS CTA | MPR Batch Files |
| PROTOCOL | 15 mm MIPs |
| | Sagittal and coronal MPR through |
| | pancreas |
| | 5 mm increments |
| | Oblique MPR angled with body |
| | 3 mm increments |
| | Oblique MPR angled with tail |
| | 3 mm increments |
| | Curved reformat (CPR) of pancreatic duct |
| | (MinIP) |
| | Batch file of longitudinal CPR |
| | views |
| | Additional images as appropriate |
| | Vessel encasement by tumor |
| | Arterial anomalies |
| | Stenosis |
| ORTHOPEDIC CT | MPR Batch Files |
| PROTOCOL | Original slice thickness |
| | Sagittal and coronal oblique MPR |
| | angled through the joint space |
| | 3 mm increments |
| | Volume Views |
| | Remove all casts or splints |
| | Segment out normal bone to reveal |
| | fracture sites |
| | 360 rotational views w/wo |
| | shadowed articulating bones |
| | Additional snapshots that best |
| | demonstrate the fracture site |
| SPINE CT PROTOCOL | MPR Batch Files |
| | Original slice thickness |
| | Sagittal and coronal MPR (bone |
| | and soft tissue window) |
| | 3 mm increments |
| | Oblique MPR through |
| | neuroforamina |
| | 3 mm increments |
| | Curved reformats for C/T/L spine |
| | Volume Views |
| | Midsagittal view to demonstrate |
| | spinal stenosis |
| | If fractured |
| | Segment out normal bone to |
| | reveal fracture sites |
| | 360 rotational views w/wo |
| | shadowed articulating bones |
| | Additional snapshots that |
| | best demonstrate the |
| | fracture site |
| | Fusion follow up |
| | Demonstrate pedicle screw |
| | placement |
| | Volume views of hardware |
| | in bone |

Of course, it should be understood that protocols such as shown above are not the only instruction or information which could be provided to a technologist with a scan. Other instruction which could be provided includes technical instruction such as:

To quickly get to the segmented volume of a case which has been processed:
1. Open the right side panel in the main control screen.
2. Click on the ‘ROI’ tab in the upper right.
3. Under the drop down menu (“New Segmentation”) select the appropriate file.
4. Uncheck the “External” visible option at the top of the list to see segmented vessels.

To quickly analyze a vessel:
1. Use the small artery option for coronary arteries; for all else, use the regular artery.
2. Pick on the “Append Control Points” button.
3. Place two or more points in either the MPRs or volume.
4. Click “Trace”.
5. Check Curved View (lower right panel of screen) to see a CPR in the volume window.

Accordingly, the discussion of protocols set forth above should be understood to be illustrative only, and should not be treated as limiting on the claims included in this or any related application.

In addition to (or as an alternative to) using protocols such as described above to provide instruction to technologists in how postprocessing should proceed, protocols such as described above can be used in routing postprocessing tasks to appropriate technologists. For example, there could be a database maintained by an outsourced postprocessor which stores skill indicators reflecting the competencies for the various technologists. These skill indicators could include indications of whether the technologist has been certified in performance of a particular protocol, what the technologist's experience is with a protocol, the training level of a technologist, a technologist's seniority, and other potentially relevant information. To use this information, the software used to allocate scans could automatically retrieve the skill indicators for the technologists, compare the protocol (or compare necessary postprocessing tasks, in a case where protocols such as described are not used and/or applicable) for a scan with the skill indicators, and then allocate the scan to the technologist who was indicated as being most appropriate. Of course, a variety of other approaches can also be tried, either in combination with the use of protocols in determining how a scan should be assigned, or as an alternative to the use of the protocols as described above. For example, if the entity providing the scan (e.g., a doctor or a hospital) indicates a preference for a particular technologist to process the scan, then the software used to determine how the scan would be allocated could seek to allocate the scan in accordance with the expressed preferences. Additionally, the software used to allocate a scan could determine how long the postprocessing for the scan is likely to take, and then assign the scan based on which technologists have time available to complete the postprocessing (e.g., try to avoid assigning a scan to a technologist who would not be able to complete it before a shift change). The software could also try and level the workload for the technologists, or could base assignments on the equipment available and/or the ability of technologists to perform the necessary processing using the available equipment. Of course, other approaches to determining which technologist would process a scan could also be used, and the approaches described above should be understood to be illustrative only, and not limiting.

Yet another process which could be performed by an outsourced postprocessor such as described above is the maintenance of statistics and other performance data for the technologists who perform the postprocessing. Such data could be gathered and maintained in a variety of manners. For example, in connection with the quality control discussed above, the technologists who perform postprocessing on a scan can be rated, for example by grades (e.g., A, B, C, F), by scores showing relative performance (e.g., quality in the 95 percentile), by scores showing requirements met (e.g., 5 out of 7 measured characteristics present), or by some other type of rating. These ratings can then be stored in a database, potentially along with the time required by the technologist to perform the postprocessing, and used to determine information such as whether there are problem areas for the particular technologist (e.g., the technologist may have high ratings for some protocols, but low ratings for others), whether the technologist requires additional training, whether the technologist is below average in efficiency, or other information which could be useful to making sure that all technologists are effectively able to perform their duties. It is also possible that the information in the database can be used to compile performance statistics for a technologist, or for a group of technologists, and that those performance statistics could be used to create a more complete picture of the overall operation of the outsourced postprocessor (e.g., such as might be provided by a dashboard application, or which could help the postprocessor relate costs to revenues).

In terms of training which could be provided to a technologist, table 2, below, illustrates one exemplary structure for how such training could be organized:

TABLE 2
Exemplary training structure

| | |
|---|---|
| Sectional Anatomy | Head |
| | Brain |
| | Neck |
| | Spine |
| | Thorax |
| | The Heart and Coronary Vessels |
| | Abdomen & Pelvis |
| | Lower Extremity |
| | Upper Extremity |
| | Vasculature of the Body |
| Radiographic Pathology | Coronary Artery Disease |
| | Cardiac Function |
| | Carotid Artery Disease and Stroke |
| | Peripheral Artery Disease |
| | Aortic Aneurysms |
| | Abdomen Diseases |
| | Pulmonary Diseases |
| | Neurological Pathology |
| Post Processing Techniques and | The Voxel: A Review of CT Physics |
| Terminology | Hounsfield Units & Windowing |
| | Multiplanar Reformats (MPRs), MIPs |
| | and CPRs |
| | Introduction to the CT Volume |
| | Postprocessing Measurements |
| | Volume Segmentation |
| | Vessel Analysis |
| | The Gated Cardiac Scan |
| | Advanced Visualization and |
| | Colormaps |
| Protocols and Case Studies | Cardiac CTA Protocol & Case Study |
| | Carotid CTA Protocol & Case Study |
| | Circle of Willis CTA Protocol & Case |
| | Study |
| | Arterial Runoff CTA Protocol & Case |
| | Study |
| | Aortic CTA Protocol & Case Study |
| | Spine CT Protocol & Case Study |
| | Living Donor Evaluation CTA |
| | Protocol & Case Study |
| | Brain Perfusion |
| | Virtual Bronchoscopy Protocol & Case |
| | Study |
| | Pancreatic Masses |
| | IVP/Urogram |
| Complete Modules | Carotid |
| (modules which incorporate | Cardiac |
| aspects of the above modules | COW and Perfusion |
| to provide an overview of | CTA Runoff |
| specific case types) | AAA |
| | TAA |
| | Abdominal Masses |
| | Spinal Analysis |
| | Orthopedics |

With a structure such as shown, an outsourced postprocessor such as described previously could use the data collected on individual technologists to identify areas where the technologist has difficulty, and assign remedial training as appropriate. Once appropriate training is completed, the completion information could be used to help assure customers of the outsourced postprocessor that the technologists employed by the postprocessor are competent to perform the tasks assigned. For example, in a case where training is assigned based on a technologist's performance statistics, indications of completion can be used to update skill indicators for the technologist to indicate that the difficulties which resulted in the assignment of training appear to have been remediated.

Of course, the use of modules such as described above is not limited to the context of remedial training. For example, an outsourced postprocessor could have a requirement for technologists to complete basic training comprising one or more of the modules described above before being assigned to perform postprocessing tasks. This could be achieved by having software which determines when a new technologist is added to the postprocessor's staff (e.g., by being automatically notified when a new technologist is added, or by regularly reviewing the postprocessor's roster and assigning training in the event of relevant changes, etc), and then transmits a message requesting training to the database storing the training modules. Then when the new technologist actually completes the training, the server used by the technologist for routing could receive a training completion skill indicator, which could indicate to the routing server that the technologist is qualified to perform one or more postprocessing operations covered by the training. Of course, routing scans according to which modules had been completed by which technologists is not limited to the case of introductory training. The same techniques can be used in the case of remedial training, or other types of training (e.g., training which a technologist might have undergone before working for the postprocessor). Accordingly, the above discussion of assignment of training modules, and routing of scans based on those modules, should be understood as being illustrative only, and not limiting.

Turning now to a discussion of specific techniques for the implementation of training such as described above, it is possible that the modules shown in table 2 could be implemented as self contained units which could be presented to technologists as appropriate based the technologists' performance statistics, or other factors as set forth above. In such an implementation utilizing self-contained modules, the student could be provided with a set of presentation information which could include one or more modules appropriate for the student. The modules themselves would include instruction (e.g., a video of course material, a step by step walkthrough of a particular set of postprocessing tasks, a demonstration of a protocol, interactive software which would allow the student to experiment with the material being presented, or some other type of information as might be appropriate), and an evaluation. Such an evaluation, when completed, would show that the technologist to whom the module is presented has achieved some desired level of competence. Such an evaluation might involve providing a scan to the student, who would then use the same type of thin client software discussed previously to process it. The commands performed by the student, or the finished product of the postprocessing, or both, could be used in determining the student's performance. Of course, other types of evaluations, such as multiple choice tests, essays, fill in the blanks, and true/false tests could also be utilized, and may be more or less appropriate than the use of thin client (or other postprocessing software) depending on the specifics of a particular situation. Further, in the case where the presentation information comprises instructions for the student regarding features which should be looked for and pointed out to a doctor for a case, and how those features can be found, the evaluation might actually comprise having a doctor review the student's output, and verify that the appropriate features had actually been pointed out. Once the evaluation had been successfully completed, a certificate (or some other type of skill indicator) could be derived and issued reflecting the fact that the technologist had achieved a desired level of competence in the material covered by the module.

While the above discussion of training focused on training provided in the context of the operations of an outsourced postprocessor, it should be understood that such training is not limited to being provided by an outsourced postprocessor. For example, other institutions, such as universities, could provide training using modules such as shown as part of their curriculum, or there could be third party providers which could use modules such as shown as part of private training programs which could be offered to those wishing to improve their skills. In some such cases, at the completion of the training, the students who undergo the training could be provided with continuing education units (CEUs) which might be necessary for those students to obtain or maintain certain licenses (e.g., students who are radiologic technologists). It is also possible that the operations of an outsourced postprocessor could be combined with programs offered by other entities, such as universities, so as to optimally utilize the resources of both parties. As an example of this, consider the situation in which a university maintains a database which includes a plurality of training modules, while an outsourced postprocessor maintains a multi-user thin client server. In this case, the university and postprocessor could work together to provide training, for instance, with the university assigning postprocessing exercises to its students, which would then use the thin client server at the postprocessor to complete those exercises. After postprocessing was complete, the thin client server could send the results of that postprocessing to the university database (either directly, or through some intermediary such as a gateway server as described above). The university could then use those results to derive a skill indicator for the student, and store that skill indicator in its database. In exchange for the use of the postprocessor's equipment, the university could provide job training to the postprocessor's personnel. For example, the postprocessor could use its routing and assignment servers to retrieve skill indicators for its technologist and send those indicators to the database maintained by the university. The university could retrieve an appropriate exercise based on the skill indicator, and then provide that exercise to the technologist in the same manner described above for the student enrolled at the university. Indeed, in some cases the technologist might actually be enrolled in the university. Of course, other arrangements, including payments of money are also possible. Accordingly, the discussion of collaboration between a university (or other type of institution) and outsourced postprocessor should be understood as being illustrative only, and not limiting.

Similarly, while the above disclosure focused largely on the operations of an outsourced postprocessor, it should be understood that the disclosed technology is not limited to being utilized by an outsourced postprocessor, and could be used by hospitals, doctors' offices, or other types of entities which perform medical image postprocessing. Additionally, as mentioned, the disclosure herein is intended only to illustrate the inventors' technology, and is not intended to disclose every possible implementation of that technology contemplated by the inventors. Numerous variations on, and departures from, the explicit disclosure of this application are contemplated by the inventors, and will be apparent to one of ordinary skill in the art in light of this application. Accordingly, the protection provided to the inventors by this document should not be limited to the material explicitly disclosed. Instead, such protection should be understood to be defined by the following claims, which are drafted to reflect the scope of protection sought by the inventors in this document when the terms in those claims which are listed below under the label “Explicit Definitions” are given the explicit definitions set forth therein, and the remaining terms are given their broadest reasonable interpretation as shown by a general purpose dictionary. To the extent that the interpretation which would be given to the claims based on the above disclosure or the incorporated priority documents is in any way narrower than the interpretation which would be given based on the “Explicit Definitions” and the broadest reasonable interpretation as provided by a general purpose dictionary, the interpretation provided by the “Explicit Definitions” and broadest reasonable interpretation as provided by a general purpose dictionary shall control, and the inconsistent usage of terms in the specification or priority documents shall have no effect.

### Explicit Definitions

When used in the claims, “based on” should be understood to mean that something is determined at least in part by the thing that it is indicated as being “based on.” When something is completely determined by a thing, it will be described as being “based EXCLUSIVELY on” the thing.

When used in the claims, “database” should be understood to refer to a set of organized information classified according to the content of the information in the “database.” For the purpose of clarity, it should be understood that a “database” can be a dedicated system (e.g., a server which serves purely as a repository of information), or could be integrated with other systems (e.g., a “database” could be stored on a server which is used for other tasks, potentially including the storage of other “databases”).

When used in the claims, “medical image postprocessing” should be understood to mean performing one or more operations on a plurality of medical images (e.g., one or more CT or MRI slices) to create a new data set, where the new data set includes at least one image which is derived from information from more than one image from the original plurality of medical images, and where the new data set allows a doctor to visualize information which was obscured in the original plurality of medical images (e.g., the path of a blood vessel which might not have been completely visible in any one of the original medical images) but which is helpful for the diagnosis and treatment of a patient. It should be understood that “medical image postprocessing” is not itself diagnosis or treatment of a patient, and should not be confused with, or treated as the same as or equivalent to, such diagnosis or treatment (e.g., the creation of a report by a radiologist). As an example to illustrate this distinction, “medical image postprocessing” might be used to create a three dimensional image from a set of two dimensional slices. The resulting three dimensional image might then be examined by a radiologist to diagnose the cause of a patient's ailment. The actions by the radiologist in diagnosing the patient would not be medical image postprocessing.

When used in the claims, “medical image postprocessing protocols” should be understood to mean an output specification which instructs a technologist how to create a three dimensional image from a plurality of slices included in a scan, and which identifies specific information which should be highlighted (e.g., a two dimensional picture of an area of interest, such as could be obtained from a screen capture) as potentially being of use for a doctor to consider in the diagnosis and treatment of a patient. For the sake of clarity, it should be understood that, in some implementations, the creation of a three dimensional image might not involve the actual duplication of data from the plurality of slices, but could instead be accomplished by creating a dataset which includes instructions that modify the appearance of the underlying data in the plurality of slices. Similarly, the phrase “output specification,” should not be treated as implying that “medical image postprocessing protocols” indicate how to create only a single image. Instead, the “output” could include multiple images, and might also include non-image information, such as notes.

When used in the claims, “postprocessing server” should be understood to mean a system configured with instructions (which might themselves be embodied in various manners including but not limited to hardware, software, firmware, or combinations thereof) and components (e.g., network port(s), processor(s), etc . . . ) which allow the “postprocessing server” to receive commands used in medical image postprocessing from a remotely located terminal, to execute those commands, and to communicate the results of those commands to the remotely located terminal.

When used in the claims, “quality control review” should be understood to mean review of a deliverable performed internally by an entity on a deliverable which has either been sent to a customer, or which is intended to be sent to a customer without further modification.

When used in the claims, “radiologic technologist” should be understood to mean an individual having specialized knowledge of the operation of radiologic imaging devices, or one who is employed as such.

When used in the claims, “located remotely” or the adjective “remote” used in conjunction with the term “location” should be understood to mean located in a physically separate location. In the case of communication with a device (e.g., a server) which is located at a remote location, the communication with the device at the remote location travels over a network.

When used in the claims, “student” should be understood to mean an individual formally enrolled in an education program wherein the student seeks and is provided with knowledge using materials designed for the purpose of providing knowledge to the “student.”

When used in the claims, “terminal” should be understood to mean a device with which a user directly interacts. For example, if a user enters commands into a thin client machine which are then transmitted and executed by a remote postprocessing server, the thin client machine would be a “terminal.”

When used in the claims, “volumetric imaging technologist” should be understood to mean an individual who has been trained specifically in the creation a composite image from a plurality of slices through medical image postprocessing to facilitate diagnosis or treatment by another individual or entity (e.g., a radiologist), or one who is employed to create a composite image from a plurality of slices through medical image postprocessing to facilitate diagnosis or treatment by another individual or entity. It should be understood that a “composite image” is an image which is derived from information from more than one underlying image (e.g., a three dimensional image created from a plurality of slices, or a reconstructed two dimensional image of a particular plane which is oblique to the imaging plane of an underlying plurality of slices). It should also be understood that a “volumetric imaging technologist” might also be trained or employed to create multiple composite images, and might be trained or employed to produce deliverables other than such composite images.

We claim:

1. A system comprising:
a) an upload interface, said upload interface operable by personnel at a medical imaging facility to specify a scan for medical image postprocessing;
b) a database, said database configured to receive said scan specified through said upload interface;
c) a first server configured to:
i) convert a notation associated with said scan into a normal form;
ii) automatically retrieve from a storage medium a plurality of skill indicators for a plurality of volumetric imaging technologists;
iii) automatically allocate said scan to a first volumetric imaging technologist from said plurality of volumetric imaging technologists for medical image postprocessing based on a comparison between a skill indicator for said first volumetric imaging technologist and a medical image postprocessing requirement for said scan; and
iv) provide said scan to a second server;
d) the second server, wherein said second server comprises
i) a network connection configured to receive a plurality of commands input by said first volumetric imaging technologist into a volumetric imaging technologist terminal located remotely from said second server; and
ii) a processor configured to perform medical image postprocessing operations on said scan by executing said plurality of commands from said first volumetric imaging technologist.

2-9. (canceled)

10. A system comprising:
a) a database, said database storing data correlating one or more volumetric imaging technologists with one or more skill indicators;
b) a server, said server configured to:
i) allocate a scan to a first volumetric imaging technologist, said scan comprising one or more images, said first volumetric imaging technologist selected from said one or more volumetric imaging technologists based on a relationship between one or more skill indicators for said first volumetric imaging technologist and a set of medical image postprocessing activities to be performed for said scan;
ii) provide the scan to the first volumetric imaging technologist in combination with a medical image postprocessing protocol indicating the set of medical image postprocessing activities to be performed for said scan;
iii) receive a set of data from said first volumetric imaging technologist, said set of data comprising an image obtained from said scan through performance of said set of medical image postprocessing activities; and
iv) store said set of data in a computer readable medium;
c) a network connection, said network in communication with said server such that said network connection is configured to transmit said set of data stored on said computer readable medium by said server.

11-17. (canceled)

18. A method comprising:
a) establishing a connection between a terminal located proximate to a student and a postprocessing server located remotely from the student;
b) providing a set of presentation information to the student, wherein the set of presentation information comprises a module training the student in performance of a medical image postprocessing protocol;
c) providing an evaluation to said student, wherein providing said evaluation to said student comprises providing said student a scan;
d) receiving a set of student input in response to said evaluation, wherein receiving the set of student input comprises receiving, via said connection, a set of commands from said terminal, wherein said set of commands from said terminal comprise postprocessing commands input by said student to execute the medical image postprocessing protocol for said scan;
e) executing, via said postprocessing server, said set of commands;
f) deriving a skill indicator for said student based on said set of student input;
g) transmitting a set of display information from said postprocessing server to said terminal, said set of display information indicating a result of execution of said set of commands; and
h) storing sad skill indicator in a computer readable medium.

19-20. (canceled)
